(19) United States
(12) Patent Application Publication
(10) Pub. No.: US 2023/0388988 A1
(43) Pub. Date: Nov. 30, 2023

(54) METHOD, APPARATUS OF SCHEDULING RESOURCE FOR TERMINAL DEVICE

(71) Applicant: Telefonaktiebolaget LM Ericsson (publ), Stockholm (SE)

(72) Inventors: Jie Chen, Beijing (CN); Bela Rathonyi, Lund (SE); Kenneth Sandberg, Ekerö (SE); Liping Zhang, Beijing (CN)

(21) Appl. No.: 18/026,393

(22) PCT Filed: Jul. 27, 2021
(86) PCT No.: PCT/CN2021/108683

§ 371 Date: Mar. 15, 2023

(30) Foreign Application Priority Data
Sep. 21, 2020 (WO) PCT/CN2020/116559

(51) Int. Cl. H04W 72/0453

(52) U.S. Cl. CPC H04W 72/0453

(57) ABSTRACT

Embodiments of the present disclosure relates to a method, and an apparatus of scheduling resource for terminal device. The method performed by a network node comprise: obtaining a configuration indicating that a resource is associated to a first operation mode, or indicating that the resource is associated to a second operation mode; and transmitting, to a terminal device, a first message indicating that the resource is associated to the second operation mode. The first operation mode comprises a standalone mode; and the second operation mode comprises a guardband mode or an inband mode. According to embodiments of the present disclosure, the network node may change a preconfigured operation mode of a specific resource, so as to improve the utilization efficiency of the specific resource.

### TECHNICAL FIELD

The present disclosure relates generally to the technology of wireless communication, and in particular, to a method, and an apparatus of scheduling resource for terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

In the wireless communication network, limited communication resources are dynamically used by the network node, such as a base station, for the terminal device, such as a user equipment, UE. Some communication resources are preconfigured with a specific scheduling manner, so as to improve scheduling efficiency, etc. For example, in narrow band internet of things, NB-IoT, communication, different frequency resources may be previously associated to different operation/deployment mode.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

These preconfigured specific scheduling manners (such as the previously associated operation modes) are usually determined by some standards/technology specifications, thus it is considered that the network node and the terminal device may communicate with each other efficiently according to the same standards/technology specifications. However, such pre-configuration sometimes does not provide a preferred manner to utilize the communication resource.

Certain aspects of the present disclosure and their embodiments may provide solutions to these or other challenges. There are, proposed herein, various embodiments which address one or more of the issues disclosed herein. For example, in an embodiment of the present disclosure, the network node may change a preconfigured operation mode of a specific resource, so as to improve the utilization efficiency of the specific resource.

A first aspect of the present disclosure provides a method performed by a network node, comprising: obtaining a configuration indicating that a resource is associated to a first operation mode, or indicating that the resource is associated to a second operation mode; and transmitting, to a terminal device, a first message indicating that the resource is associated to the second operation mode. The first operation mode comprises a standalone mode; and the second operation mode comprises a guardband mode or an inband mode.

In an embodiment of the present disclosure, the configuration further indicates that an operation mode of the resource is changeable by the network node.

In an embodiment of the present disclosure, the resource associated to the guardband mode is deployed without having any associated long term evolution, LTE, cell or NR cell.

In an embodiment of the present disclosure, the resource is used for narrow band internet of things communication.

In an embodiment of the present disclosure, the first message indicates that the resource comprises an anchor carrier; and a center frequency of the anchor carrier has a first offset to a frequency raster.

In an embodiment of the present disclosure, the second operation mode comprises the guardband mode.

In an embodiment of the present disclosure, a granularity of the frequency raster is 100 KHz; and the first offset may be selected from {−7.5, −2.5, 2.5, 7.5} KHz.

In an embodiment of the present disclosure, the method further comprises: transmitting, to the terminal device, a second message indicating that a non-anchor carrier is associated to the second operation mode. The non-anchor carrier has a channel number with a second offset to a downlink absolute radio frequency channel number; and the second offset may be selected from {−10, −9, −8, −7, −6, −5, −4, −3, −2, −1, −0.5, 0, 1, 2, 3, 4, 5, 6, 7, 8, 9}.

In an embodiment of the present disclosure, the second message comprises a contention resolution message.

In an embodiment of the present disclosure, the contention resolution message includes any one of RRCConnectionSetup-NB, or RRCConnectionReestablishment-NB, or RRCConnectionResume-NB for indicating that the non-anchor carrier is associated to the second operation mode, when the terminal device is changing from RRC idle mode to RRC connected mode.

In an embodiment of the present disclosure, the second message comprises RRCConnectionReconfiguration-NB for indicating that the non-anchor carrier is associated to the second operation mode, when the terminal device is in RRC connected mode.

In an embodiment of the present disclosure, the second message comprises SystemInformationBlockType22-NB for indicating that the non-anchor carrier is associated to the second operation mode, when the terminal device is in RRC idle mode.

In an embodiment of the present disclosure, the configuration further indicates that the non-anchor carrier is associated to the first operation mode, or indicates that the non-anchor carrier is associated to the second operation mode.

In an embodiment of the present disclosure, a space is arranged between the non-anchor carrier and the anchor carrier; and the space includes 0 to 7 subcarriers.

In an embodiment of the present disclosure, a carrier spacing from a center of the anchor carrier to a center of the non-anchor carrier is 180+n*15 kHz, n=0, 1, . . . , 7.

In an embodiment of the present disclosure, the method further comprises: applying an inverse fast Fourier transform and/or a fast Fourier transform for radio signals on the resource, separately with radio signals out of the resource.

In an embodiment of the present disclosure, the method further comprises: applying common public radio interface channels and filtering process for radio signals on the resource, separately with radio signals out of the resource.

In an embodiment of the present disclosure, the network node comprises a base station.

In an embodiment of the present disclosure, the first message comprises a broadcasting message including a master information block and/or a system information block.

A second aspect of the present disclosure provides a network node, comprising: a processor; and a memory, the memory containing instructions executable by the processor, whereby the first network node is operative to: obtain a configuration indicating that a resource is associated to a first operation mode, or indicating that the resource is associated to a second operation mode; and transmit, to a terminal device, a first message indicating that the resource is associated to a second operation mode. The first operation mode comprises a standalone mode; and the second operation mode comprises a guardband mode or an inband mode.

In an embodiment of the present disclosure, the network node is further operative to the method according to any of the above-mentioned embodiments.

A third aspect of the present disclosure provides a computer readable storage medium comprising instructions which when executed by a processor, cause the processor to perform the method according to any of the above-mentioned embodiments.

A fourth aspect of the present disclosure provides a network node, comprising: an obtaining unit, configured to obtain a configuration indicating that a resource is associated to a first operation mode, or indicating that the resource is associated to a second operation mode; and a transmitting unit, configured to transmit, to a terminal device, a first message indicating that the resource is associated to the second operation mode. The first operation mode comprises a standalone mode; and the second operation mode comprises a guardband mode or an inband mode.

In an embodiment of the present disclosure, the network node may be further operative to the method according to any of the above-mentioned embodiments.

According to embodiments of the present disclosure, the network node may change a preconfigured operation mode of a specific resource. Therefore, the flexibility for scheduling the resource for the terminal device may be improved. Particularly, the utilization efficiency of the specific resource may be improved.

### BRIEF DESCRIPTION OF DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1A is a diagram showing an example of standalone anchor and non-anchor deployment with smallest distance of 300 KHz with a legal value of M_{DL} in the technical specifications.

FIG. 1B is a diagram showing another example of standalone anchor and non-anchor without spare subcarriers.

FIG. 2A is an exemplary flow chart showing a method performed at a network node, according to embodiments of the present disclosure.

FIG. 2B is an exemplary flow chart showing an additional step of the method performed at a network node, according to embodiments of the present disclosure.

FIG. 2C is an exemplary flow chart showing other additional steps of the method performed at a network node, according to embodiments of the present disclosure.

FIG. 3 is a diagram showing an example of standalone anchor and non-anchor without spare subcarriers, according to embodiments of the present disclosure.

FIG. 4A is an exemplary diagram showing an NB-IoT cell deployment with separate IFFT/FFT but inside the system bandwidth.

FIG. 4B is another exemplary diagram showing an NB-IoT cell deployment with 5 non-anchor carriers.

FIG. 4C is another exemplary diagram showing an NB-IoT cell deployment with 7 non-anchor carriers.

FIG. 5 is an exemplary diagram showing a functional unit according to embodiments of the present disclosure.

FIG. 6A is an exemplary diagram showing a Standalone NB-IoT downlink signal generation procedure, according to embodiments of the present disclosure.

FIG. 6B is an exemplary diagram showing a NB-IoT Guardband/Inband downlink signal generation procedure with joint IFFT/Filtering, according to embodiments of the present disclosure.

FIG. 6C is an exemplary diagram showing a NB-IoT guardband downlink signal generation procedure with separate IFFT/Filtering, according to embodiments of the present disclosure.

FIG. 7 is a block diagram showing the network node in accordance with embodiments of the present disclosure.

FIG. 8 is a block diagram showing a computer readable storage medium in accordance with embodiments of the present disclosure.

FIG. 9 is a schematic showing function units of the network node in accordance with embodiments of the present disclosure.

FIG. 10 is a schematic showing a wireless network in accordance with some embodiments.

FIG. 11 is a schematic showing a user equipment in accordance with some embodiments.

FIG. 12 is a schematic showing a virtualization environment in accordance with some embodiments.

FIG. 13 is a schematic showing a telecommunication network connected via an intermediate network to a host computer in accordance with some embodiments.

FIG. 14 is a schematic showing a host computer communicating via a base station with a user equipment over a partially wireless connection in accordance with some embodiments.

FIG. 15 is a flowchart illustrating a method implemented in a communication system, in accordance with one embodiment.

FIG. 16 is a flowchart illustrating a method implemented in a communication system, in accordance with one embodiment.

FIG. 17 is a flowchart illustrating a method implemented in a communication system, in accordance with one embodiment.

FIG. 18 is a flowchart illustrating a method implemented in a communication system, in accordance with one embodiment.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network”, or “communication network/system” refers to a network/system following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device with accessing function in a communication network via which a terminal device accesses to the network and receives services therefrom. The network node may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In some 3rd generation partnership project technical specifications, 3GPP TS, some communication resources are configured to be associated with specific scheduling manner, and/or operation/deployment modes. Below, NB-IoT resources will be taken as example for better illustration, but it should be understood that the embodiments of the present disclosure are not limited to the NB-IoT resources.

For example, 3GPP TS of Release-13 (Rel-13) defined 3 operation/deployment modes for NB-IoT: Inband (IB), Guardband (GB) and Standalone (SA). An NB-IoT cell consists of at least one carrier called as the anchor carrier, and may have zero or many non-anchor carriers. Each of the NB-IoT carriers have an associated operation/deployment mode, i.e. one of IB/GB/SA. IB NB-IoT carriers are located inside an LTE cell, GB NB-IoT carriers are located in the guard-band of an LTE cell, and SA NB-IoT carriers are not associated to any LTE cell and are usually located in a narrow frequency fragment, for example in a reframed GSM frequency band.

The effective signal bandwidth of one NB-IoT carrier is 180 KHz for all deployment modes which is same as one physical resource block (PRB) of an LTE cell. A downlink anchor carrier always includes synchronization signals and system information, i.e. NPSS/NSSS/NPBCH/SIB-NB (Narrow-band Primary Synchronization Signal/Narrow-band Secondary Synchronization Signal/Narrow-band Physical Broadcast Channel/System Information Block-Narrow-band). As a result, an NB-IoT UE will perform cell search on the anchor carrier to get the deployment information based on the operationModeInfo-r13 parameter from MasterInformationBlock-NB, which is transmitted on the NPBCH. These parameters are highlighted (bold) in the below.

| | |
|---|---|
| MasterInformationBlock-NB ::= | SEQUENCE { |
| systemFrameNumber-MSB-r13 | BIT STRING (SIZE (4)), |
| hyperSFN-LSB-r13 | BIT STRING (SIZE (2)), |
| schedulingInfoSIB1-r13 | INTEGER (0..15), |
| systemInfoValueTag-r13 | INTEGER (0..31), |
| ab-Enabled-r13 | BOOLEAN, |
| operationModeInfo-r13 | CHOICE { |
| inband-SamePCI-r13 | Inband-SamePCI-NB-r13, |
| inband-DifferentPCI-r13 | Inband-DifferentPCI-NB-r13, |
| guardband-r13 | Guardband-NB-r13, |
| standalone-r13 | Standalone-NB-r13 |
| }, | |
| spare | BIT STRING (SIZE (11)) |
| } | |

ChannelRasterOffset-NB-r13 ::= ENUMERATED {khz-7dot5, khz-2dot5, khz2dot5, khz7dot5}

| | |
|---|---|
| Guardband-NB-r13 ::= | SEQUENCE { |
| rasterOffset-r13 | ChannelRasterOffset-NB-r13, |
| spare | BIT STRING (SIZE (3)) |
| } | |
| Inband-SamePCI-NB-r13 ::= | SEQUENCE { |
| eutra-CRS-SequenceInfo-r13 | INTEGER (0..31) |
| } | |
| Inband-DifferentPCI-NB-r13 ::= | SEQUENCE { |
| eutra-NumCRS-Ports-r13 | ENUMERATED {same, four}, |
| rasterOffset-r13 | ChannelRasterOffset-NB-r13, |
| spare | BIT STRING (SIZE (2)) |
| } | |
| Standalone-NB-r13 ::= | SEQUENCE { |
| spare | BIT STRING (SIZE (5)) |
| } | |

To reduce the UE cell search time, the EARFCN (Evolved Universal Terrestrial Radio Access Absolute Radio Frequency Channel Number) of anchor carrier must be aligned to the 100 KHz raster, refer to, e.g., 3GPP TS36.101 (Version 16.6.0), clause 5.7.2. GB/IB carriers may have a non-zero offset to the 100 KHz raster caused by the additional LTE DC (direct current) subcarrier to keep the orthogonality among subcarriers. As can be seen, above ChannelRasterOffset-NB-r13 (±2.5 KHz or ±7.5 KHz) is used for GB/IB to get the exact frequency information. SA anchor carrier needs to exactly align to the 100 KHz raster, since there is no DC carrier at all.

In Rel-13, non-anchor carrier frequency information is transmitted in CarrierConfigDedicated-NB-r13 (in msg4) so a UE can be moved to a non-anchor carrier for CONNECTED mode unicast transmissions. Rel-14 extended this mechanism to support for Paging and/or Random Access on non-anchor(s) which have the carrier information in SystemInformationBlockType22-NB.

The carrier frequency definition in ASN.1 (Abstract Syntax Notation One) looks as follows:

| | |
|---|---|
| CarrierFreq-NB-r13 ::= | SEQUENCE { |
| carrierFreq-r13 | ARFCN-ValueEUTRA-r9, |
| carrierFreqOffset-r13 | ENUMERATED { |
| | v-10, v-9, v-8, v-7, v-6, v-5, v-4, v-3, v-2, v-1, |
| | v-0dot5, v0, v1, v2, v3, v4, v5, v6, v7, v8, v9 |
| | } OPTIONAL -- Need ON |

The relation between EARFCN, Offset and the carrier frequency in MHz for the downlink are defined, e.g., in clause 5.7.3 of 3GPP TS 36.101 (Version 16.6.0), which is incorporated herein by reference as its entirety, as below:

“5.7.3F Carrier frequency and EARFCN for category NB1 and NB2

The carrier frequency of category NB1/NB2 in the downlink is designated by the E-UTRA Absolute Radio Frequency Channel Number (EARFCN) in the range 0-262143 and the Offset of category NB1/NB2 Channel Number to EARFCN in the range {−10,−9,−8,−7,−6,−5,−4,−3,−2,−1,−0.5,0,1,2,3,4,5,6,7,8,9}. The relation between EARFCN, Offset of category NB1/NB2 Channel Number to EARFCN and the carrier frequency in MHz for the downlink is given by the following equation, where F_{DL} is the downlink carrier frequency of category NB1/NB2, F_{DL_low} and N_{Offs-DL} are given in table 5.7.3-1, N_{DL} the downlink EARFCN, M_{DL} is the Offset of category NB1/NB2 Channel Number to downlink EARFCN.

F_{DL}=F_{DL_low}+0.1(N_{DL}−N_{Offs-DL})+0.0025*(2M_{DL}+1)”

In Rel-13 and Rel-14, the combination of anchor and non-anchor carriers for different modes is limited as shown in the below table. As can be seen, the SA cannot be used together with GB/IB carriers.

TABLE 1
combination possibility between different
modes in Rel-13 and Rel-14

| Anchor\Non- | Inband(Non- | Guardband(Non- | Standalone(Non- |
|---|---|---|---|
| anchor | anchor) | anchor) | anchor) |
| Inband(Anchor) | Yes | Yes | N/A |
| Guardband(Anchor) | Yes | Yes | N/A |
| Standalone(Anchor) | N/A | N/A | Yes |

In 3GPP Rel-15 support for mix mode configuration with SA carriers was added based on the UE capability. If the UE signals mixedOperationMode-r15 then all the carrier combinations can be supported.

| PhyLayerParameters-NB-v1530 ::= | SEQUENCE { | |
|---|---|---|
| mixedOperationMode-r15 | ENUMERATED {supported} | OPTIONAL, |
| sr-WithHARQ-ACK-r15 | ENUMERATED {supported} | OPTIONAL, |
| sr-WithoutHARQ-ACK-r15 | ENUMERATED {supported} | OPTIONAL, |
| nprach-Format2-r15 | ENUMERATED {supported} | OPTIONAL, |
| additionalTransmissionSIB1-r15 | ENUMERATED {supported} | OPTIONAL, |
| npusch-3dot75kHz-SCS-TDD-r15 | ENUMERATED {supported} | OPTIONAL |

TABLE 2
combination possibility between different modes in Rel-15

| Anchor\Non- | Inband(Non- | Guardband(Non- | Standalone(Non- |
|---|---|---|---|
| anchor | anchor) | anchor) | anchor) |
| Inband(Anchor) | Yes | Yes | Yes |
| Guardband(Anchor) | Yes | Yes | Yes |
| Standalone(Anchor) | Yes | Yes | Yes |

The above configurations may lead to problems about utilization efficiency of the communication resources.

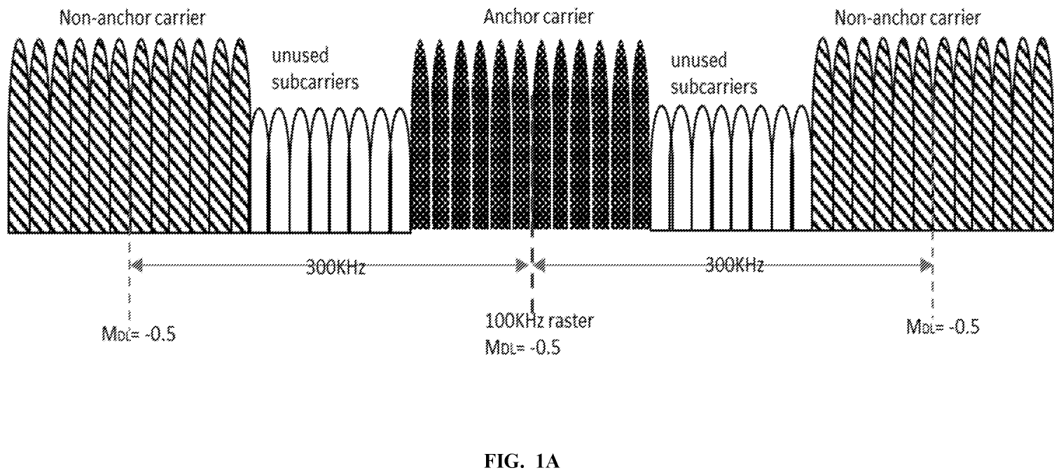

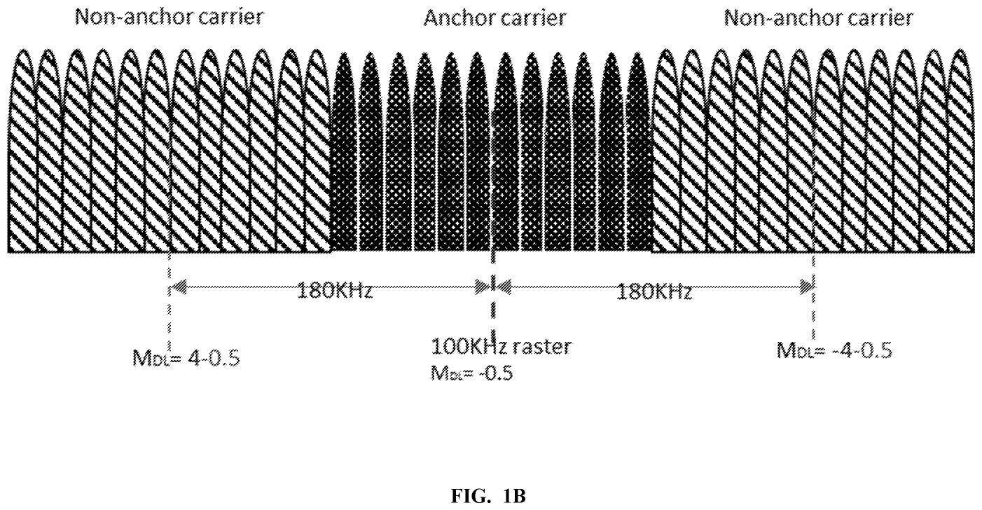

FIG. 1A is a diagram showing an example of standalone anchor and non-anchor deployment with smallest distance of 300 KHz with legal value of M_{DL} in the technical specifications.

For example, in 3GPP Rel-13 36.101 (Version 16.6.0) 5.7.3F, only M_{DL}=−0.5 is applicable for stand-alone resulting in that the following formula for DL can be deduced as:

F_{DL}=F_{DL_low}+0.1(N_{DL}−N_{Offs-DL})+0.0025*(2*−0.5+1)=F_{DL_low}+0.1(N_{DL}−N_{Offs-DL})

“NOTE 2: For stand-alone operation, only M_{DL}=−0.5 and M_{UL}=0 are applicable.”

Based on the above restriction the non-anchor carrier frequency for standalone also needs to align to the 100 KHz raster. This leads to that the closest carrier space between the anchor carrier and a non-anchor carrier is 300 KHz(15 KHz*20) to keep the orthogonality on subcarrier level (15 Khz subcarrier). Thus, there will be 8 empty subcarriers between the two NB-IoT carriers which is a waste of valuable spectrum resources; where the number of empty subcarriers 8 comes from (300 kHz−180 kHz)/15 kHz.

3GPP Rel-14 was supposed to improve the resource allocation efficiency for standalone multi-carrier in RP (Radio Acess Network Plenary)—171299 CR (Change Request) 4460. The change allows a deviation from the 100 kHz channel raster positions for an SA NB-IoT carrier by restricting that the M_{DL}=−0.5 only apply for the anchor carrier.

In RP-171299, the changes are as follows:
“NOTE 1: For category NB1/NB2, N_{DL} or N_{UL} is different than the value of EARFCN that corresponds to E-UTRA downlink or uplink carrier frequency for in-band and guard band operation.
NOTE 2: M_{DL}=−0.5 is not applicable for in-band and guard band operation.
NOTE 3: For the carrier including NPSS/NSSS for in-band and guard band operation, M_{DL} is selected from {−2, −1, 0, 1}.
NOTE 4: For the carrier including NPSS/NSSS for stand-alone operation, M_{DL}=−0.5. <End of change>”

In Rel-14, the flexibility to allocate NB-IoT standalone carriers has been increased to some extent. However, when an operation mode of the anchor carrier is a standalone mode, in practice it didn't change the result that the smallest carrier space between standalone anchor carrier and non-anchor carrier is still 300 KHz (15 KHz*20) to keep the orthogonality on subcarrier level as illustrated in below table. This table lists the different number of empty subcarriers between anchor and non-anchor carrier, the offset from 100 KHz raster for non-anchor carrier(M_{DL}) shows that only −0.5 is available from the defined value range {−10,−9,−8,−7,−6,−5,−4,−3,−2,−1,−0.5,0,1,2,3,4,5,6,7,8,9}, so there is no difference compared to Rel-13.

TABLE 3
M_{DL} values corresponding to different numbers of empty subcarriers

| Empty subcarriers between Anchor | | | | | | | | | |
|---|---|---|---|---|---|---|---|---|---|
| and non-anchor | 0 | 1 | 2 | 3 | 4 | 5 | 6 | 7 | 8 |
| Offset from Anchor (KHz) | 180 | 195 | 210 | 225 | 240 | 255 | 270 | 285 | 300 |
| Offset from 100 KHz raster (KHz) | −20 | −5 | 10 | 25 | 40 | −45 | −30 | −15 | 0 |
| M_{DL} | −4.5 | −1.5 | 1.5 | 4.5 | 7.5 | −9.5 | −6.5 | −3.5 | −0.5 |

FIG. 1B is a diagram showing another example of standalone anchor and non-anchor without spare subcarriers.

When an M_{DL} value −0.5 is used for the anchor, the non-anchors at two sides of the anchor must have a M_{DL} value 4−0.5=3.5, and a M_{DL} value −4−0.5=−4.5, respectively. These M_{DL} values of the non-anchors are still not existing in the carrierFreqOffset-r13 list.

Another problem is that Rel-13/Rel-14 UEs and Rel-15 (or even later) UEs without the mixedOperationMode capability can't use the mix anchor and non-anchor mode with SA carriers. The SA carriers are usually located in frequency fragments close to GB/IB carriers, so lack of support by some UEs will impact the flexibility and complexity of multiple carrier deployments to distribute different UEs into different carriers.

Certain aspects of the present disclosure and their embodiments may be described below to provide solutions to these or other challenges.

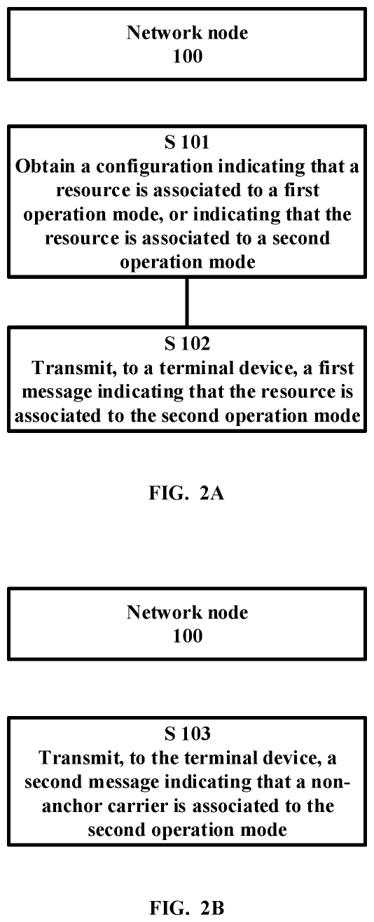

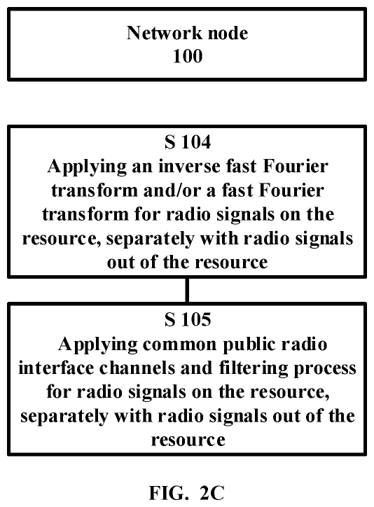

FIG. 2A is an exemplary flow chart showing a method performed at a network node 100, according to embodiments of the present disclosure.

As shown in FIG. 2A, the method comprises: S101, obtaining a configuration indicating that a resource is associated to a first operation mode, or indicating that the resource is associated to a second operation mode; and S102, transmitting, to a terminal device, a first message indicating that the resource is associated to the second operation mode. The first operation mode comprises a standalone mode; and the second operation mode comprises a guardband mode or an inband mode.

According to embodiments of the present disclosure, the network node may change a preconfigured operation mode of a specific resource. Therefore, the flexibility for scheduling the resource for the terminal device may be improved. Particularly, the utilization efficiency of the specific resource may be improved.

Particularly, the operation mode may be changed from the standalone mode to the guardband mode or the inband mode. The network node may record that the mode is changed, but the terminal device may utilize the resource as it is originally in guardband or inband mode, without knowing the changing procedure (namely, extra capability of terminal device is not needed).

Additionally, the original second operation mode for any resource may not to be changed.

In an embodiment of the present disclosure, the configuration further indicates that an operation mode of the resource is changeable by the network node.

According to embodiments of the present disclosure, the network node may change a preconfigured operation mode of a specific resource, based on the configuration. Thus, the flexibility for scheduling the resource may be further improved.

In an embodiment of the present disclosure, the resource associated to the guardband mode is deployed without having any associated long term evolution, LTE, cell or NR cell.

In an embodiment of the present disclosure, the resource is used for narrow band (NB) internet of things (IoT) communication.

In an embodiment of the present disclosure, the first message indicates that the resource comprises an anchor carrier; and a center frequency of the anchor carrier has a first offset to a frequency raster.

In an embodiment of the present disclosure, the second operation mode comprises the guardband mode.

Namely, the standalone mode may be changed to the guardband mode. Particularly, the standalone mode of the anchor carrier may be changed to the guardband mode. Then, the anchor carrier with guardband mode may be configured with an offset to a frequency raster.

In an embodiment of the present disclosure, a granularity of the frequency raster is 100 KHz; and the first offset may be selected from, e.g., {−7.5, −2.5, 2.5, 7.5} KHz. The {−7.5, −2.5, 2.5, 7.5} KHz is only an example of the present disclosure, and the first offset may be selected form other offset set.

In a further embodiment of the present disclosure, the offset, particularly of the anchor carrier in GB or IB mode, may be selected from the {−7.5, −2.5, 2.5, 7.5} KHz. The offset for the carriers in SA mode may be set as 0.

FIG. 2B is an exemplary flow chart showing an additional step of the method performed at a network node, according to embodiments of the present disclosure.

In an embodiment of the present disclosure, the method further comprises: S103, transmitting, to the terminal device, a second message indicating that a non-anchor carrier is associated to the second operation mode. The non-anchor carrier has a channel number with a second offset to a downlink absolute radio frequency channel number; and the second offset may be selected from, e.g., {−10, −9, −8, −7, −6, −5, −4, −3, −2, −1, −0.5, 0, 1, 2, 3, 4, 5, 6, 7, 8, 9}. The above offset set is only an example of the present disclosure, the second offset may be selected from other offset set.

In an embodiment of the present disclosure, the second message comprises a contention resolution message (e.g. MSG 4), or any other kind of radio resource control (RRC) message.

In an embodiment of the present disclosure, the contention resolution message includes any one of RRCConnectionSetup-NB, or RRCConnectionReestablishment-NB, or RRCConnectionResume-NB for indicating that the non-anchor carrier is associated to the second operation mode, when the terminal device is changing from RRC idle mode to RRC connected mode.

In an embodiment of the present disclosure, the second message comprises RRCConnectionReconfiguration-NB for indicating that the non-anchor carrier is associated to the second operation mode, when the terminal device is in RRC connected mode.

In an embodiment of the present disclosure, the second message comprises SystemInformationBlockType22-NB for indicating that the non-anchor carrier is associated to the second operation mode, when the terminal device is in RRC idle mode.

That is, the non-anchor carrier mode and frequency information may be provided in RA msg4 for the UE changing from RRC idle mode to RRC connected mode, including RRCConnectionSetup-NB/RRCConnectionReestablishment-NB/RRCConnectionResume-NB, or provided in RRCConnectionReconfiguration-NB for UE in RRC connected mode to reconfigure to different non-anchor carriers.

In RRC idle mode SystemInformationBlockType22-NB may be used to indicate the non-anchor carrier mode and frequency information for paging monitoring and Random Access on non-anchor carriers.

In an embodiment of the present disclosure, the configuration further indicates that the non-anchor carrier is associated to the first operation mode, or indicates that the non-anchor carrier is associated to the second operation mode.

In an embodiment of the present disclosure, a space is arranged between the non-anchor carrier and the anchor carrier; and the space includes 0 to 7 subcarriers.

In an embodiment of the present disclosure, a carrier spacing from a center of the anchor carrier to a center of the non-anchor carrier is 180+n*15 kHz, n=0, 1, . . . ,7.

According to embodiments of the present disclosure, with the first offset and the second offset, the flexibility of arranging the anchor and non-anchor carriers may be improved. Particularly, it is possible to arrange no wasted subcarrier between the anchor and non-anchor carriers, while maintain the orthogonality between different carriers.

FIG. 2C is an exemplary flow chart showing other additional steps of the method performed at a network node, according to embodiments of the present disclosure.

In an embodiment of the present disclosure, the method further comprises: S104, applying an inverse fast Fourier transform (IFFT) and/or a fast Fourier transform (FFT) for radio signals on the resource, separately with radio signals out of the resource.

In an embodiment of the present disclosure, the method further comprises: S015, applying common public radio interface channels and filtering process for radio signals on the resource, separately with radio signals out of the resource.

According to embodiments of the present disclosure, some signal processing manners associated to the operation mode may be also configurable/selectable by the network node.

For example, for the operation mode guardband, radio signals on the resource (NB IoT anchor, or non-anchor) may be processed (e.g. transformed, or filtered) separately from radio signals out of the resource (e.g., LTE/NR signals), rather than being combined with the radio signals out of the resource.

In an embodiment of the present disclosure, the network node comprises a base station, such as NodeB or NB, eNodeB or eNB, gNodeB or gNB.

In an embodiment of the present disclosure, the first message comprises a broadcasting message including a master information block (MIB) and/or a system information block (SIB), an RRC signaling, or any other message.

According to embodiments, the base station may be improved with capability to perform the above mentioned methods, and thus the terminal device needs not to be changed/upgraded. Even the UE does not support “mixedOperationMode-r15”, it can still benefit from the above mentioned methods. Therefore, the compatibility may be also improved.

Particularly, the embodiments of the present disclosure may be applicable to standalone mode multi-carrier operations.

In such implementations, a standalone NB-IoT cell will shift the anchor carrier from the 100 KHz raster, and the operationModeInfo-r13 as transmitted over the interface Uu to the UE will be changed to guardband mode for the anchor carrier. The non-anchor carrier(s) of the cell will use either guardband mode or in-band mode.

So, basically an NB-IoT cell using GB mode is deployed without having any associated LTE cell and can be deployed within any frequency fragment, i.e. it is not restricted to a frequency located in the guardband of an LTE cell.

Therefore, different from conventional 3GPP definition of guardband mode which always associate to an LTE or NR carrier, with embodiments of the present disclosure, the guardband mode NB-IoT can be deployed to any frequency fragment without association to LTE/NR.

The flexibility and the efficiency for scheduling the communication resource may be improved.

Therefore, the embodiments of the present disclosure may optimize the spectrum usage and enables allocation of more non-anchor carriers for an NB-IoT cell within frequency fragments in a flexible way.

It further enables NB-IoT UEs without mixedOperationMode capability (i.e. also including all Rel-13 and Rel-14 UEs) to operate in NB-IoT cells that have anchor and non-anchor carriers in different frequency fragments.

As exemplary implementations without limitation, embodiments with more details will be further illustrated below.

In one embodiment, the standalone NB-IoT cell will shift the anchor carrier from the 100 KHz raster (by ±2.5 KHz or ±7.5 KHz) and the operationModeInfo-r13 is changed to guardband-r13 for the anchor carrier. The ChannelRasterOffset-NB-r13 will be set to shifted frequency. Non-anchor carriers use either guardband mode or in-band mode. In one embodiment, the eNB IFFT operation for OFDM (Orthogonal Frequency Division Multiplexing) signal generation with guardband mode will be done without the presence of any LTE PRBs.

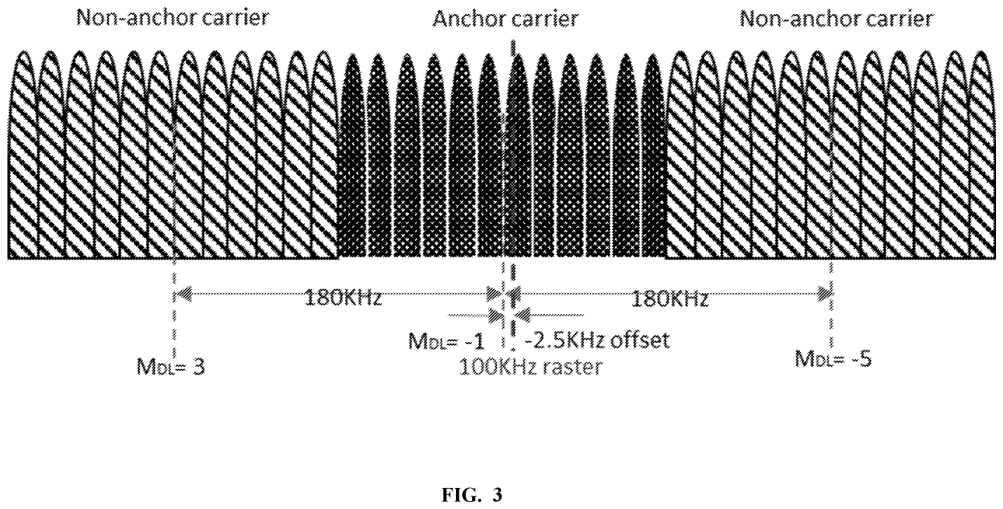

FIG. 3 is a diagram showing an example of standalone anchor and non-anchor without spare subcarriers, according to embodiments of the present disclosure.

FIG. 3 provides the example of −2.5 KHz shift/offset for anchor carrier and two non-anchor carriers using guardband mode on each side of the anchor carrier, with an anchor to non-anchor carrier spacing of 180 kHz. The M_{DL} can be retrieved from the legacy table for guardband. Within this example, the operationModeInfo-r13 of MasterInformationBlock-NB is overridden (from standalone-r13) to guardband-r13, and the rasterOffset-r13 is khz-2dot5, which means 0.0025*(2M_{DL}+1)=−0.0025 MHz so the M_{DL} of anchor carrier is −1. The left side non-anchor carrier has 200−180−2.5=17.5 KHz=0.0175 MHz=0.0025*(2M_{DL}+1) offset to the nearest 100 KHz raster so M_{DL} is 3. The M_{DL} of right side non-anchor carrier is −5, which has −22.5 KHz offset to nearest 100 KHz raster. All of these values of M_{DL} can be selected from the legacy table.

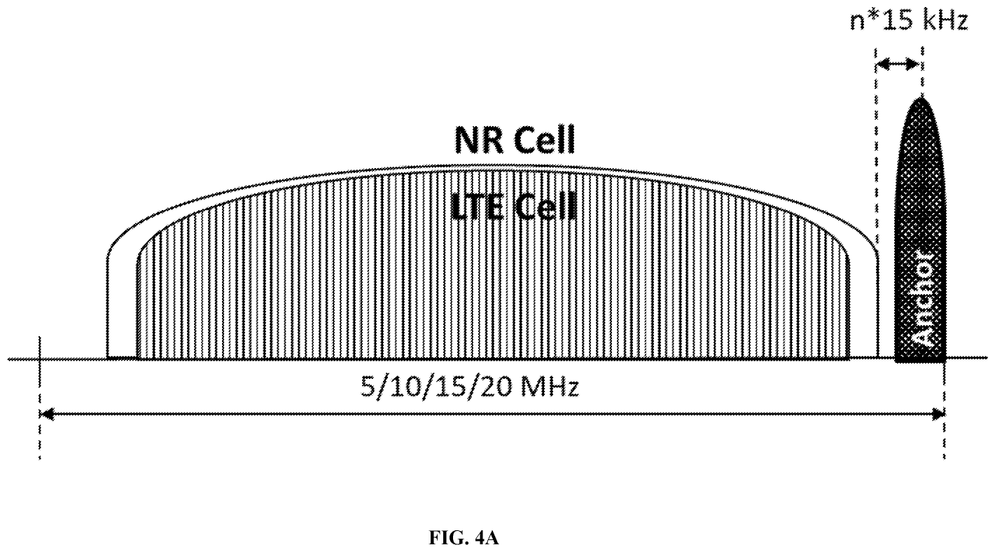

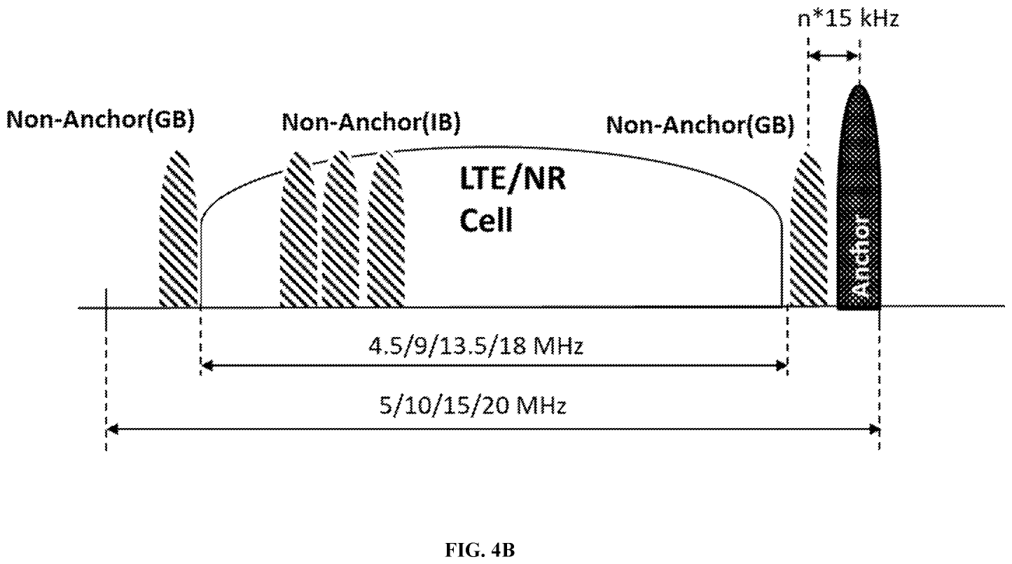

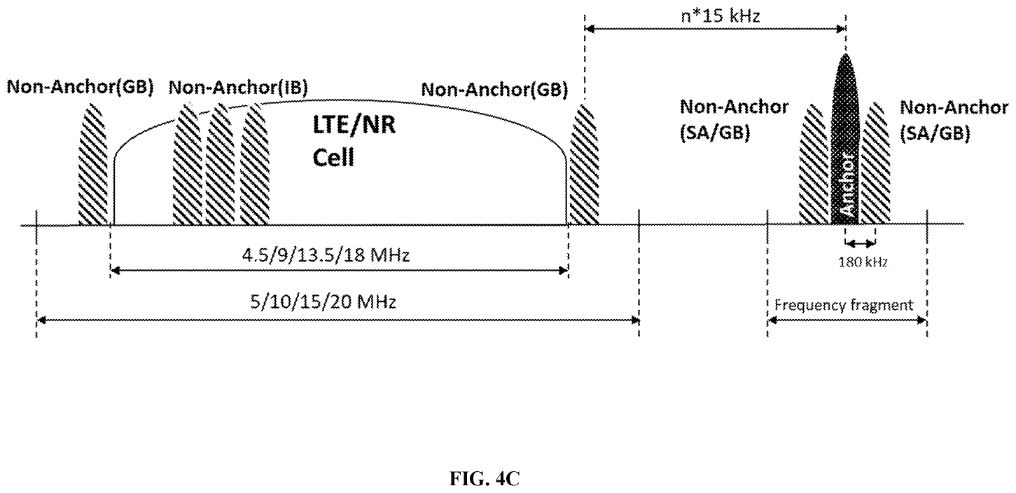

FIG. 4A is an exemplary diagram showing an NB-IoT cell deployment with separate IFFT/FFT but inside the system bandwidth.

In one embodiment for the standalone NB-IoT cell, eNB uses separated IFFT/FFT and CPRI(Common Public Radio Interface) channels and filtering for the radio signals deployed close to LTE/NR carrier. With this frequency shift solution, orthogonality is maintained with LTE/NR carrier, and the NB-IoT carrier can be deployed close to each other with less interference. FIG. 4 shows an illustration of one such example of NB-IoT with standalone mode and shift, to do separate filter/clipping, and being deployed in side of LTE/NR system BW (bandwidth) and being orthogonal with each other.

FIG. 4B is another exemplary diagram showing an NB-IoT cell deployment with 5 non-anchor carriers.

In one embodiment with mixed frequency fragment resources and inband/guardband resources with an LTE carrier, the need for UEs supporting mixedOperationMode could be avoided. FIG. 4B shows an illustration of one such example of NB-IoT deployment where the anchor carrier together with non-anchor carriers (GB and IB) associated with an LTE cell.

FIG. 4C is another exemplary diagram showing an NB-IoT cell deployment with 7 non-anchor carriers.

In one embodiment with mixed frequency fragment resources and inband/guardband resources with an LTE carrier, the need for UEs supporting mixedOperationMode could be avoided. FIG. 4C shows an illustration of one such example of NB-IoT deployment where the anchor carrier together with two non-anchor carriers are deployed according to this embodiments in a frequency fragment (non-anchor (SA/GB)) similar to FIG. 3, and the rest of the non-anchor carriers (GB and IB) are associated with an LTE cell.

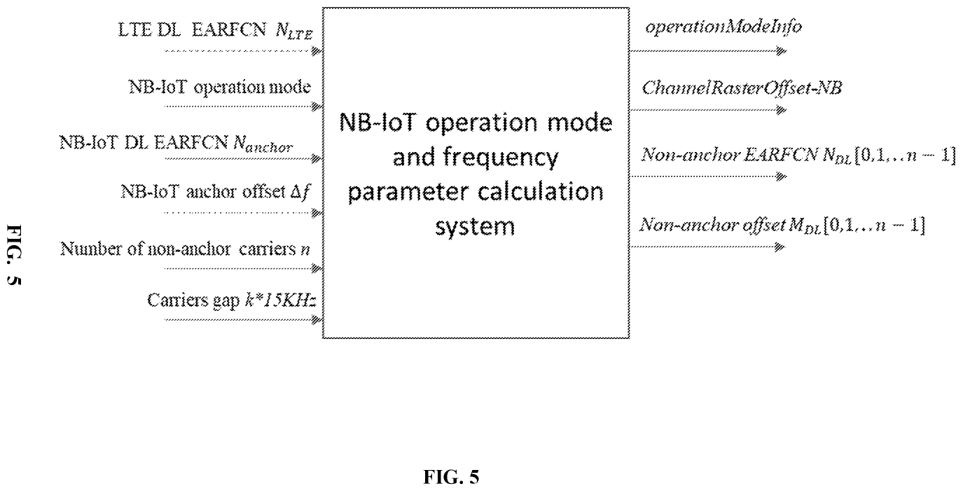

FIG. 5 is an example showing a functional unit according to embodiments of the present disclosure. The exemplary input paramenters and output parameters of the above-mentioned methods may be illustrated in the FIG. 5.

Below table list some examples of outputs calculated based on specific inputs combination.

TABLE 4
examples of outputs and inputs combinations

| | Examples | 1 | 2 | 3 | 4 | 5 | 6 | 7 |
|---|---|---|---|---|---|---|---|---|
| Input | LTE EARFCN N_{LTE} | N/A | N/A | N/A | N/A | N/A | N/A | Valid |
| | NB-IoT operation | SA | SA | SA | SA | SA | SA | SA |
| | mode | | | | | | | |
| | NB-IoT DL | Vaild | Vaild | Vaild | Vaild | Vaild | Vaild | Vaild |
| | EARFCN N_{anchor} | | | | | | | |
| | NB-IoT anchor offset | N/A | 2.5 | −2.5 | 7.5 | −7.5 | 2.5 | N/A |
| | Δf (KHz) | | | | | | | |
| | Number of non-anchor | 0 | 2 | 2 | 2 | 2 | 2 | 0 |
| | carriers n | | | | | | | |
| | Carriers gap k*15 KHz | N/A | 0 | 0 | 0 | 0 | 15 KHz | N/A |
| Output | operationModeInfo | SA | GB | GB | GB | GB | GB | GB |
| | ChannelRasterOffset- | N/A | 2.5 KHz | −2.5 KHz | 7.5 KHz | −7.5 KHz | 2.5 KHz | depend |
| | NB | | | | | | | on N_{LTE} |
| | | | | | | | | and |
| | | | | | | | | N_{anchor} |
| | Non-anchor EARFCN | N/A | N_{anchor} − | N_{anchor} − | N_{anchor} − | N_{anchor} − | N_{anchor} − | N/A |
| | N_{DL} [0] | | 2 | 2 | 2 | 2 | 2 | |
| | Non-anchor offset | N/A | 4 | 3 | 5 | 2 | 1 | N/A |
| | M_{DL} [0] | | | | | | | |
| | Non-anchor EARFCN | N/A | N_{anchor} + | N_{anchor} + | N_{anchor} + | N_{anchor} + | N_{anchor} + | N/A |
| | N_{DL} [1] | | 2 | 2 | 2 | 2 | 2 | |
| | Non-anchor offset | N/A | −4 | −5 | −3 | −6 | −1 | N/A |
| | M_{DL} [1] | | | | | | | |

Input parameters may be defined as follows:
LTE EARFCN N_{LTE}: LTE EARFCN, optional, only valid when NB-IoT need co-exist with LTE.
NB-IoT operation mode: Standalone(SA), guardband(GB) or inband(IB), standalone means dedicate IFFT/FFT/CPRI is used, otherwise joint IFFFT/FFT and CPRI are shared with LTE carrier.
NB-IoT DL EARFCN N_{anchor}: The DL EARFCN of NB-IoT anchor carrier.
NB-IoT anchor offset Δf: The frequency offset of NB-IoT anchor carrier to 100 KHz raster, valid values are from {−7.5 KHz, −2.5 KHz, 2.5 KHz, 7.5 KHz}, N/A means system will decide the offset based on other parameters.
Number of non-anchor carriers n: The number of non-anchor carriers in same continuous frequency fragment.
Carriers gap k*15 KHz: The number (k) of empty 15 KHz sub-carriers between NB-IoT carriers.

Output parameters may be defined as follows:
operationModeInfo: Standalone(SA), guardband(GB) or inband(IB). If the input NB-IoT operation mode is standalone but the anchor offset Δf is one of {−7.5 KHz, −2.5 KHz, 2.5 KHz, 7.5 KHz} or LTE EARFCN is valid so the NB-IoT carrier need to co-exist with LTE, then operationModeInfo will be changed to guardband, otherwise the operationModeInfo will keep the same as input operation mode.

ChannelRasterOffset-NB: The ChannelRasterOffset-NB-r13 IE (information element) in MasterInformationBlock-NB for guardband or inband, only valid when operationModeInfo is guardband or inband, same value as Δf in case of Δf is valid. In case of LTE EARFCN N_{LTE} is valid (example 7 in above table) and NB-IoT carrier need to co-exist with LTE with orthogonal in sub-carrier level then ChannelRasterOffset-NB need be calculated based on below formula (assume validation pass that the NB-IoT carrier does not overlap with the LTE PRBs):

$$offset = \{ \begin{matrix}mod ( ( ( {N}_{L T E} - {N}_{a n c h o r} ) * 1000 - 75 ) , 150 ) , {N}_{L T E} > {N}_{anchor} \\ mod ( ( ( {N}_{a n c h o r} - {N}_{L T E} ) * 1000 - 75 ) , 150 ) , {N}_{L T E} < {N}_{a n c h o r}\end{matrix}$$

wherein “mod ( )” means Modulus Operation.

For example, offset value {25, 125} are mapping to {2.5 KHz, −2.5 KHz} separately, offset value of 75 can be mapping to 7.5 KHz or −7.5 KHz depending on how to map the 12 subcarriers (counting from 1 to 12 starting from low frequency) to IFFT index, if the 6^{th} subcarrier map to IFFT index 0 then offset value of 75 map to 7.5 KHz, if the 7^{th} subcarrier map to IFFT index 0 then offset value of 75 map to −7.5 KHz.

Non-anchor EARFCN N_{DL}[0]: The DL EARFCN of first NB-IoT non-anchor carrier on the lower frequency side of anchor carrier. It can be calculated with below formula based on input of N_{anchor} and NB-IoT anchor offset Δf and Carriers gap k*15 KHz with index i=1(the first carrier on the lower side of anchor carrier).

N_{DL}=N_{anchor}−round((i*(180+k*15)−Δf)/100)

where i is an integer greater than or equal to 1 and smaller than the number of non-anchor carriers;
wherein “round ( )” means a round function.

Non-anchor offset M_{DL}[0]: The carrierFreqOffset-r13 of first NB-IoT non-anchor carrier on the lower frequency side of anchor carrier, value from list of {−10, −9, −8, −7, −6,−5,−4,−3,−2,−1,−0.5,0,1,2,3,4,5,6,7,8,9}. It can be calculated with below formula based on input of NB-IoT anchor offset Δf and Carriers gap k*15 KHz with index i=1(the first carrier on the lower side of anchor carrier):

$$offset = mod ( ( i * ( 180 + k * 15 ) - Δ f ) * 10 , 1000 / 10$$

$${M}_{DL} = \{ \begin{matrix}( ( ( 100 - offset ) / 2.5 ) - 1 ) / 2 , & offset > 50 \\ ( ( ( offset - 100 ) / 2.5 ) - 1 ) / 2 , & offset < 50\end{matrix}$$

where i is an integer greater than or equal to 1 and smaller than the number of non-anchor carriers.

The example 3 in table is illustrated in FIG. 3, the offset of the non-anchor carrier on the lower frequency side of anchor carrier can be calculated as:

offset=mod((1*(180+0*15)−(−2.5))*10,1000)/10=82.5,which is greater than 50,

then:M_{DL}=(((100−82.5)/2.5)−1)/2=3.

Non-anchor EARFCN N_{DL}[1]: The DL EARFCN of first NB-IoT non-anchor carrier on the upper frequency side of anchor carrier. It can be calculated with below formula based on input of N_{anchor} and NB-IoT anchor offset Δf and Carriers gap k*15 KHz with index i=1(the first carrier on the upper side of anchor carrier):

N_{DL}=N_{anchor}+round((i*(180+k*15)+Δf)/100)

where i is an integer greater than or equal to 1 and smaller than the number of non-anchor carriers.

Non-anchor offset M_{DL}[1]: The carrierFreqOffset-r13 of first NB-IoT non-anchor carrier on the upper frequency side of anchor carrier, value from list of {−10, −9, −8, −7, −6, −5, −4, −3, −2, −1, −0.5, 0,1, 2, 3, 4, 5, 6, 7, 8, 9}. It can be calculated with below formula based on input of NB-IoT anchor offset Δf and Carriers gap k*15 KHz with index i=1(the first carrier on the lower side of anchor carrier):

$$offset = mod ( ( i * ( 180 + k * 15 ) - Δ f ) * 10 , 1000 ) / 10$$

$${M}_{DL} = \{ \begin{matrix}( ( ( 100 - offset ) / 2.5 ) - 1 ) / 2 , & offset < 50 \\ ( ( ( offset - 100 ) / 2.5 ) - 1 ) / 2 , & offset > 50\end{matrix}$$

where i is an integer greater than or equal to 1 and smaller than the number of non-anchor carriers.

The example 3 in table is illustrated in FIG. 3, the offset of the non-anchor carrier on the upper frequency side of anchor carrier can be calculated as:

offset=mod((1*(180+0*15)+(−2.5))*10,1000)/10=77.5, which is greater than 50,then M_{DL}=((77.5−100)/2.5)−1)/2=−5.

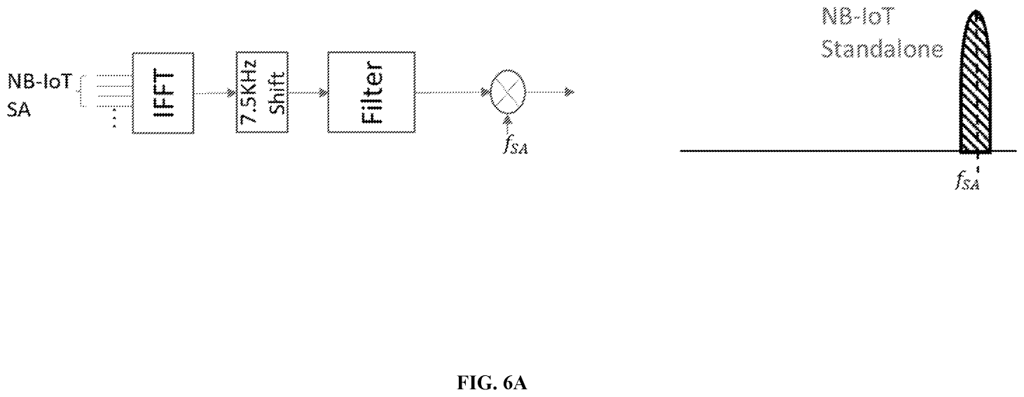

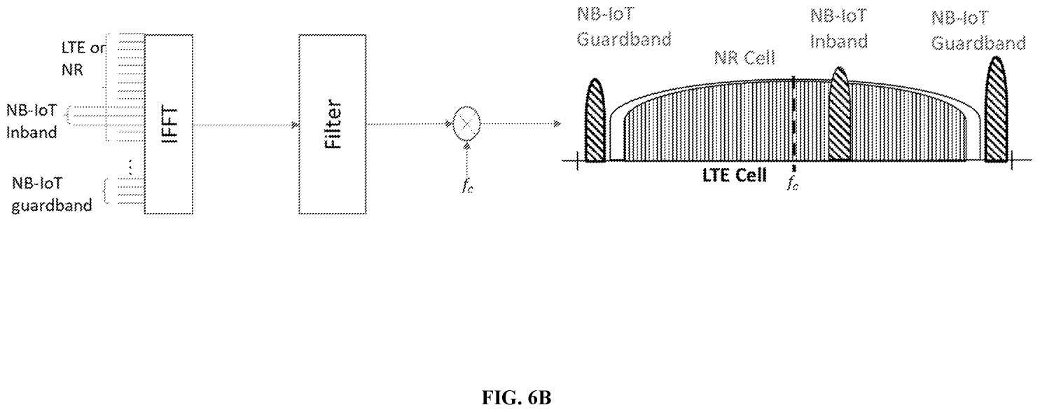

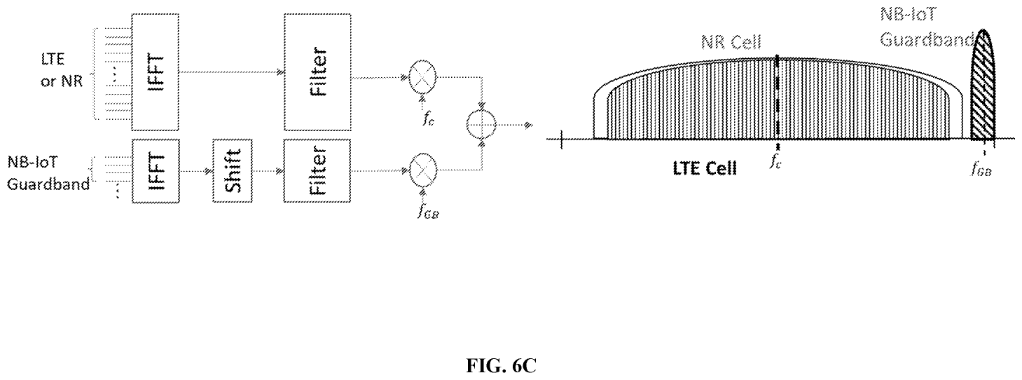

Further, some typical downlink signaling generation flow will be shown FIG. 6A-6C for Standalone and Guardband (or IB) separately.

FIG. 6A is an exemplary diagram showing a Standalone NB-IoT downlink signal generation procedure, according to embodiments of the present disclosure.

As shown in FIG. 6A, signals for NB-IoT SA mode may be transformed (by IFFT), shifted (of 7.5 KHz), filtered, and then transmitted on a carrier with the center frequency f_{SA}.

FIG. 6B is an exemplary diagram showing a NB-IoT Guardband/Inband downlink signal generation procedure with joint IFFT/Filtering, according to embodiments of the present disclosure.

As shown in FIG. 6B, signals for NB-IoT Inband, Guardband mode, together with signals for LTE or NR, may be transformed (by IFFT), filtered, and then transmitted on a carrier (combination) with the center frequency f_{c}.

FIG. 6C is an exemplary diagram showing a NB-IoT guardband downlink signal generation procedure with separate IFFT/Filtering, according to embodiments of the present disclosure.

As shown in FIG. 6C, signals for NB-IoT Guardband mode may be transformed (by IFFT), shifted, filtered, separately with signals for LTE or NR, which may be transformed (by IFFT), filtered. Signals for NB-IoT Guardband mode may be then transmitted on a carrier with the center frequency f_{GB}, simultaneously with signals for LTE or NR, which may be transmitted on a carrier with the center frequency f_{c}.

Some of the above embodiments relate to the downlink carriers/signals (for example, in FIG. 6A-6C). However, it should be understood that the embodiments of the present disclosure may also be applicable to, for example, uplink carriers/signals. Moreover, the specific offset frequency of a center frequency of any uplink carrier compared to the frequency raster can be set according to the specific situation/implementation. For example, the frequency offset can be 0 when it is not necessary for the NB-IoT carriers/signals to coexist with LTE/NR cells/carriers, and the frequency offset can be, for example, +5 KHz or −5 KHz, when it is necessary to coexist with LTE/NR cells/carriers.

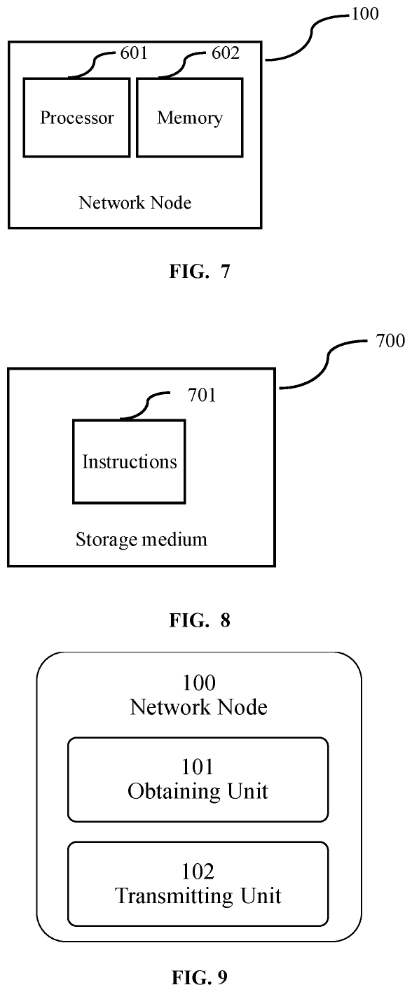

FIG. 7 is a block diagram showing the network node in accordance with embodiments of the present disclosure.

As shown in FIG. 7, the network node 100 may comprise: a processor 601; and a memory 602, the memory 602 containing instructions executable by the processor 601, whereby the network node 100 may be operative to: obtain a configuration indicating that a resource is associated to a first operation mode, or indicating that the resource is associated to a second operation mode; and transmit, to a terminal device, a first message indicating that the resource is associated to a second operation mode. The first operation mode comprises a standalone mode; and the second operation mode comprises a guardband mode or an inband mode.

In an embodiment of the present disclosure, the network node is further operative to the method according to any of the above-mentioned embodiments, such as shown in FIG. 2A-6C.

The processors 601 may be any kind of processing component, such as one or more microprocessor or microcontrollers, as well as other digital hardware, which may include digital signal processors (DSPs), special-purpose digital logic, and the like. The memories 602 may be any kind of storage component, such as read-only memory (ROM), random-access memory, cache memory, flash memory devices, optical storage devices, etc.

FIG. 8 is a block diagram showing a computer readable storage medium in accordance with embodiments of the present disclosure.

As shown in FIG. 8, the computer readable storage medium 700 comprising instructions/program 701 which when executed by a processor, cause the processor to perform any above-mentioned method, such as shown in FIG. 2A-6C.

The computer readable storage medium 700 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

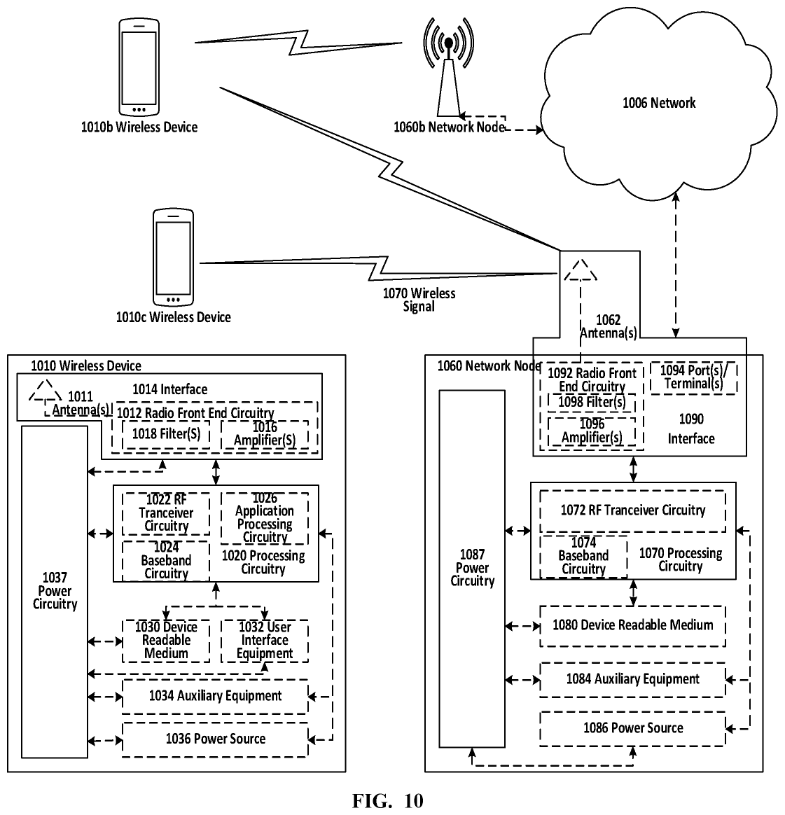

FIG. 9 is a schematic showing function units of the network node, according to embodiments of the present disclosure.

As shown in FIG. 9, the network node 100 may comprise: an obtaining unit 101, configured to obtain a configuration indicating that a resource is associated to a first operation mode, or indicating that the resource is associated to a second operation mode; and a transmitting unit 102, configured to transmit, to a terminal device, a first message indicating that the resource is associated to the second operation mode. The first operation mode comprises a standalone mode; and the second operation mode comprises a guardband mode or an inband mode.

In an embodiment of the present disclosure, the network node may be further operative to the method according to any of the above-mentioned embodiments, such as shown in FIG. 2A-6C.

According to embodiments of the present disclosure, the network node may change a preconfigured operation mode of a specific resource. Therefore, the flexibility for scheduling the resource for the terminal device may be improved. Particularly, the utilization efficiency of the specific resource.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the terminal device or network node may not need a fixed processor or memory, any computing resource and storage resource may be arranged from at least one network node, or terminal device in the communication system. The introduction of virtualization technology and network computing technology may improve the usage efficiency of the network resources and the flexibility of the network.

Further, the exemplary overall commutation system including the terminal device and the network node (the first network node and/or the second network node) will be introduced as below.

Embodiments of the present disclosure provide a communication system including a host computer including: processing circuitry configured to provide user data; and a communication interface configured to forward the user data to a cellular network for transmission to a terminal device. The cellular network includes a network node above mentioned, and/or the terminal device is above mentioned.

In embodiments of the present disclosure, the system further includes the terminal device, wherein the terminal device is configured to communicate with the network node.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a network node. The transmission is from the terminal device to the network node. The network node is above mentioned, and/or the terminal device is above mentioned.

In embodiments of the present disclosure, the processing circuitry of the host computer is configured to execute a host application. The terminal device is configured to execute a client application associated with the host application, thereby providing the user data to be received by the host computer.

FIG. 10 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 and 1060b (e.g. corresponding to the network node 100), and WDs 1010, 1010b, and 1010c (e.g. corresponding to any terminal device). In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to transmit and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to transmit and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to transmit and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

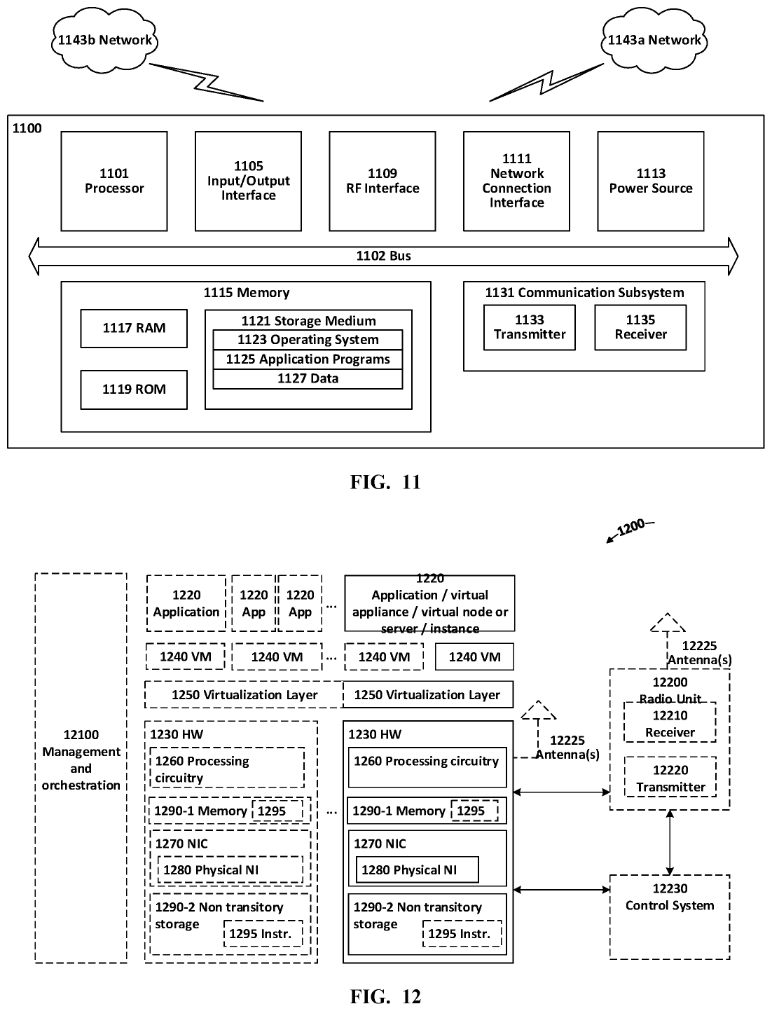

FIG. 11 is a schematic showing a user equipment in accordance with some embodiments.

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3^{rd} Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

FIG. 12 is a schematic showing a virtualization environment in accordance with some embodiments.

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

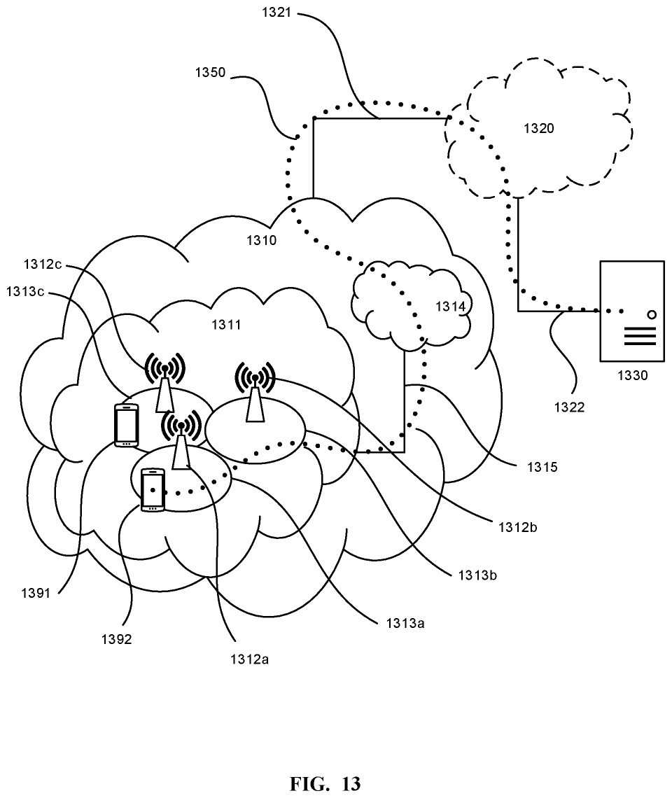

FIG. 13 is a schematic showing a telecommunication network connected via an intermediate network to a host computer in accordance with some embodiments.

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

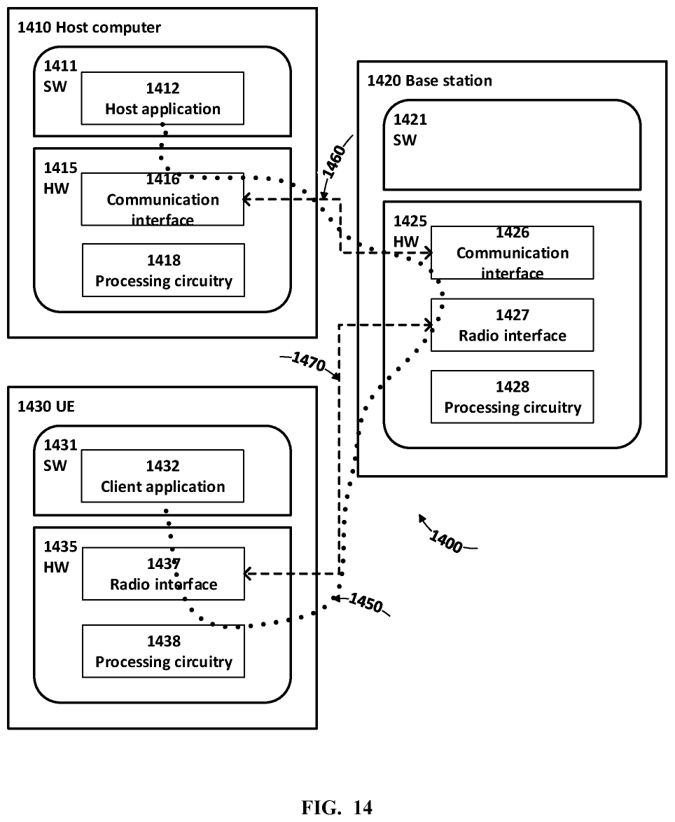

FIG. 14 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the latency, and power consumption for a reactivation of the network connection, and thereby provide benefits, such as reduced user waiting time, enhanced rate control.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

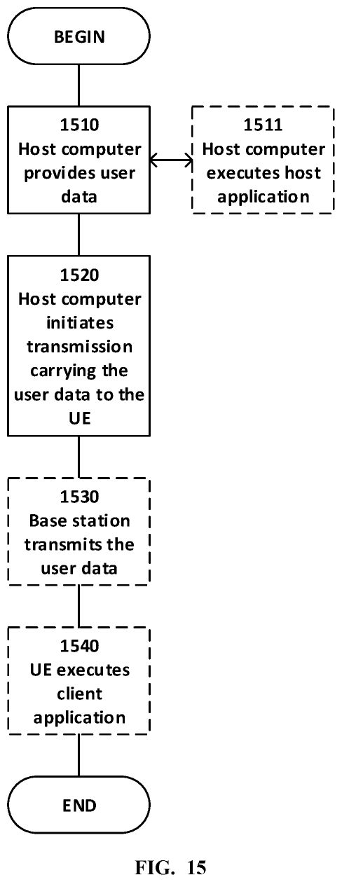

FIG. 15 is a flowchart illustrating a method implemented in a communication system, in accordance with one embodiment.

The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

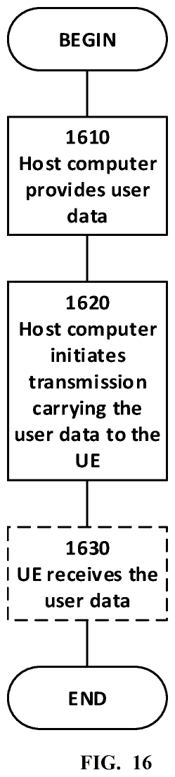

FIG. 16 is a flowchart illustrating a method implemented in a communication system, in accordance with one embodiment.

The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

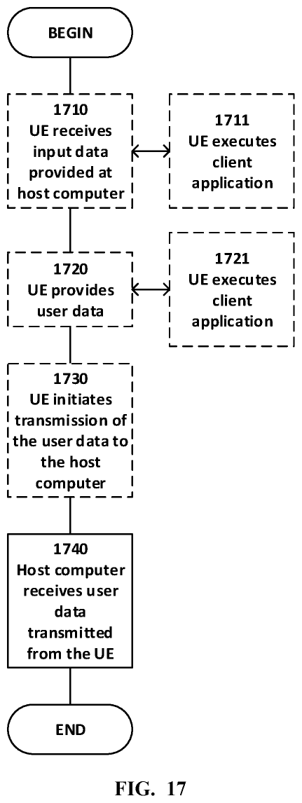

FIG. 17 is a flowchart illustrating a method implemented in a communication system, in accordance with one embodiment.

The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

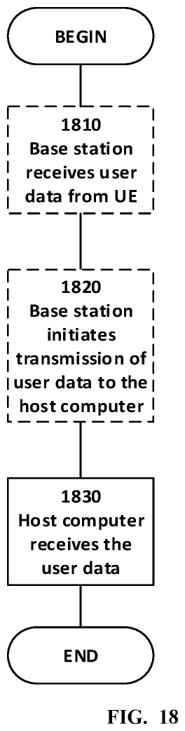

FIG. 18 is a flowchart illustrating a method implemented in a communication system, in accordance with one embodiment.

The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In general, the various exemplary embodiments of the present disclosure may be implemented in hardware or special purpose circuits, software, logic or any combination thereof. For example, some aspects may be implemented in hardware, while other aspects may be implemented in firmware or software that may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may include circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

| Abbreviation | Explanation |
|---|---|
| CPRI | Common Public Radio Interface |
| DL | Downlink |
| EDT | Early Data Transmission |
| EARFCN | E-UTRA Absolute Radio Frequency Channel Number |
| GB | Guardband |
| IB | Inband |
| LTE | Long-Term Evolution |
| MAC | Medium Access Control |
| NB-IoT | Narrowband Internet or things |
| NPRACH | NB-IoT Physical Random Access Channel |
| RA | Random Access |
| RRC | Radio Resource Control |
| SIB | System Information Block |
| SA | Standalone |
| TS | Technical Specification |
| UE | User Equipment |
| UL | Uplink |

1. A method performed by a network node, comprising:
obtaining a configuration indicating that a resource is associated to a first operation mode, or indicating that the resource is associated to a second operation mode; and
transmitting, to a terminal device, a first message indicating that the resource is associated to the second operation mode;
wherein the first operation mode comprises a standalone mode; and
wherein the second operation mode comprises a guardband mode or an inband mode.

2. (canceled)

3. The method according to claim 1,
wherein the configuration further indicates that an operation mode of the resource is changeable by the network node.

4. The method according to claim 1,
wherein the resource is used for narrow band internet of things communication.

5. The method according to claim 1,
wherein the first message indicates that the resource comprises an anchor carrier; and
wherein a center frequency of the anchor carrier has a first offset to a frequency raster.

6. The method according to claim 5,
wherein the second operation mode comprises the guardband mode.

7. The method according to claim 5,
wherein a granularity of the frequency raster is 100 KHz; and
wherein the first offset is selected from {−7.5, −2.5, 2.5, 7.5} KHz.

8. The method according to claim 1, further comprising:
transmitting, to the terminal device, a second message indicating that a non-anchor carrier is associated to the second operation mode;
wherein the non-anchor carrier has a channel number with a second offset to a downlink absolute radio frequency channel number; and
wherein the second offset is selected from {−10, −9, −8, −7, −6, −5, −4, −3, −2, −1, −0.5, 0, 1, 2, 3, 4, 5, 6, 7, 8, 9}.

9. The method according to claim 8, wherein the second message comprises a contention resolution message.

10-12. (canceled)

13. The method according to claim 8,
wherein the configuration further indicates that the non-anchor carrier is associated to the first operation mode, or indicates that the non-anchor carrier is associated to the second operation mode.

14. The method according to claim 8,
wherein a space is arranged between the non-anchor carrier and the anchor carrier; and
wherein the space includes 0 to 7 subcarriers.

15. The method according to claim 14,
wherein a carrier spacing from a center of the anchor carrier to a center of the non-anchor carrier is 180+n*15 kHz, n=0, 1, . . . ,7.

16. The method according to claim 1, further comprising:
applying an inverse fast Fourier transform and/or a fast Fourier transform for radio signals on the resource, separately with radio signals out of the resource.

17. The method according to claim 1, further comprising:
applying common public radio interface channels and filtering process for radio signals on the resource, separately with radio signals out of the resource.

18. The method according to claim 1,
wherein the network node comprises a base station.

19. The method according to claim 1,
wherein the first message comprises a broadcasting message including a master information block and/or a system information block.

20. A network node, comprising:
a processor; and
a memory, the memory containing instructions executable by the processor, whereby the first network node is operative to:
obtain a configuration indicating that a resource is associated to a first operation mode, or indicating that the resource is associated to a second operation mode; and
transmit, to a terminal device, a first message indicating that the resource is associated to a second operation mode;
wherein the first operation mode comprises a standalone mode; and
wherein the second operation mode comprises a guardband mode or an inband mode.

21. The network node according to claim 20, wherein the configuration further indicates that an operation mode of the resource is changeable by the network node.

22. (canceled)

23. The network node according to claim 20, wherein the resource is scheduled for narrow band internet of things communication.

24. The network according to claim 20, wherein the first message indicates that the resource comprises an anchor carrier; and
wherein a center frequency of the anchor carrier has a first offset to a frequency raster.

25. The network according to claim 20, wherein the second operation mode comprises the guardband mode.
